(19) United States
(12) Patent Application Publication
(10) Pub. No.: US 2017/0074188 A1
(43) Pub. Date: Mar. 16, 2017

(54) SYSTEM AND METHOD FOR CONTROLLING ENGINE OF MANUAL TRANSMISSION VEHICLE

(71) Applicant: Hyundai Motor Company, Seoul (KR)

(72) Inventor: Dong Kyun Kim, Gunpo-si (KR)

(73) Assignee: Hyundai Motor Company, Seoul (KR)

(21) Appl. No.: 14/939,977

(22) Filed: Nov. 12, 2015

(30) Foreign Application Priority Data
Sep. 14, 2015 (KR) 10-2015-0129851

(51) Int. Cl. F02D 41/02; F02D 41/10; F02D 41/26; F16H 63/50

(52) U.S. Cl. CPC F02D 41/0225; F16H 63/50; F02D 41/107; F02D 41/26

(57) ABSTRACT

A system controls an engine of a manual transmission vehicle and estimates a gear stage to control an engine speed in a race mode and recognizes a select position of an N-stage to control an engine speed at two steps during a skip-down shift in a normal mode, and a method controls an engine of a manual transmission vehicle. The method includes determining a driving mode of the vehicle and an acceleration condition and a deceleration condition when the driving mode of the vehicle is a race mode. The method controls the engine at an engine speed corresponding to an upshift when the acceleration condition is satisfied, and controls the engine at an engine speed corresponding to a downshift when the deceleration condition is satisfied.

### CROSS-REFERENCE TO RELATED APPLICATIONS

This application claims the benefit of Korean Patent Application No. 10-2015-0129851, filed on Sep. 14, 2015, the contents of which are incorporated herein by reference in its entirety.

### FIELD

The present disclosure relates to a system and method for controlling an engine of a manual transmission vehicle.

### BACKGROUND

The statements in this section merely provide background information related to the present disclosure and may not constitute prior art.

Generally, a vehicle transmission is installed between a clutch and a driving shaft to increase or decrease an engine torque depending on a running state, and is typically classified into a manual transmission and an automatic transmission.

The manual transmission includes a plurality of shifting gears that are respectively installed at a main shaft and a sub-shaft and are selectively engaged for changing the engine torque, and when a driver operates a gear lever, a shifting gear of a selected gear stage is engaged for power delivery.

A vehicle that is provided with such a manual transmission, when shifting, controls engine speed for preventing a shock occurring due to a difference between a rotation speed of an engine and a rotation speed of a transmission. That is, when a driver operates a gear lever and thus a gear stage is changed, a corresponding gear stage is recognized and then an engine speed is controlled to correspond to the corresponding gear stage.

However, such a method is inappropriate in responsiveness when a high performance vehicle or a racing vehicle is driven on a racing circuit. For example, when a gear lever is shifted from a previous stage and an acceleration pedal is simultaneously and immediately pushed down according to a heel and toe technique, the method of recognizing a gear stage and then controlling an engine speed cannot rapidly increase an engine speed.

In addition, in a skip-down shift (e.g., shifting from a 5-stage to a 3-stage) in which two or more shift stages are shifted down, since a very fast engine speed should be compensated, vehicle drivability deteriorates.

### SUMMARY

The present disclosure provides a system and method for controlling an engine of a manual transmission vehicle that can estimate a gear stage to control an engine speed in a race mode and recognize a select position of an N-stage to control an engine speed at two steps during a skip-down shift in a normal mode.

One form of the present disclosure provides a method for controlling an engine of a manual transmission vehicle, that includes: determining a driving mode of a vehicle; determining an acceleration condition and a deceleration condition when the driving mode of the vehicle is a race mode; controlling the engine at an engine speed corresponding to an upshift when the acceleration condition is satisfied; and controlling the engine at an engine speed corresponding to a downshift when the deceleration condition is satisfied.

The acceleration condition may be satisfied when a position value of an accelerator pedal is equal to or greater than a first position value, a position value of a brake pedal is less than a second position value, a vehicle speed change rate is equal to or greater than a first predetermined change rate, and an engine speed is equal to or greater than a predetermined speed.

The deceleration condition may be satisfied when the position value of the accelerator pedal is less than a third position value, the position value of the brake pedal is less than a fourth position value, and the vehicle speed change rate is less than a third predetermined change rate.

The controlling of the engine at the engine speed corresponding to the upshift may include decreasing an engine torque to a torque corresponding to a higher gear stage than a previous gear stage by a stage to control the engine speed.

The controlling of the engine at the engine speed corresponding to the downshift may include increasing an engine torque to a torque corresponding to a lower gear stage than the previous gear stage by a stage to control the engine speed.

The method may further include controlling the engine at an engine speed corresponding to an engaged gear stage when the acceleration condition and the deceleration condition are not satisfied.

The method may further include: determining whether a skip-down shift of the vehicle is required when the driving mode of the vehicle is a normal mode; detecting a select position of a gear lever when the skip-down shift is required; performing low stage compensation control depending on the select position of the gear lever; and controlling the engine at the engine speed corresponding to the engaged gear stage.

The performing of the low stage compensation control depending on the select position of the gear lever may include: controlling the engine at an engine speed corresponding to a 6-stage of the gear when the select position of the gear lever is row 3 and the previous gear stage exceeds the 6-stage; controlling the engine at an engine speed corresponding to a 4-stage of the gear when the select position of the gear lever is row 2 and the previous gear stage exceeds the 4-stage; and controlling the engine at an engine speed corresponding to a 2-stage of the gear when the select position of the gear lever is row 1 and the previous gear stage exceeds the 2-stage.

Another form of the present disclosure provides a system for controlling an engine of a manual transmission vehicle, including: a data detector configured to detect data for controlling an engine of a vehicle; a mode switch configured to determine a driving mode of the vehicle; and a controller configured to perform engine speed control by estimation of a gear stage according to an acceleration condition and a deceleration condition of the vehicle when the driving mode of the vehicle is a race mode, and to perform the engine speed control for compensating a low stage when the driving mode of the vehicle is a normal mode, based on the data detected by the data detector.

Another form of the present disclosure provides a system for controlling an engine of a manual transmission vehicle, including: a data detector configured to detect data for controlling an engine of a vehicle; a mode switch configured to determine a driving mode of the vehicle; and a controller configured to perform engine speed control by estimation of a gear stage according to an acceleration condition and a deceleration condition of the vehicle when the driving mode of the vehicle is a race mode, and to perform the engine speed control for compensating a low stage when the driving mode of the vehicle is a normal mode, based on the data detected by the data detector.

The controller, in the race mode, may control the engine at an engine speed corresponding to an upshift when the acceleration condition is satisfied.

The controller may decrease an engine torque to a torque corresponding to a higher gear stage than a previous gear stage by a stage to control the engine speed.

The acceleration condition may be satisfied when a position value of an accelerator pedal is equal to or greater than a first position value, a position value of a brake pedal is less than a second position value, a vehicle speed change rate is equal to or greater than a first predetermined change rate, and an engine speed is equal to or greater than a predetermined speed.

The controller may control the engine at an engine speed corresponding to a downshift when the deceleration condition is satisfied in the race mode.

The controller may increase an engine torque to a torque corresponding to a lower gear stage than the previous gear stage by a stage to control the engine speed.

The deceleration condition may be satisfied when the position value of the accelerator pedal is less than a third position value, the position value of the brake pedal is less than a fourth position value, and the vehicle speed change rate is less than a third predetermined change rate.

The controller may control the engine at an engine speed corresponding to an engaged gear stage when the acceleration condition and the deceleration condition are not satisfied.

The controller, when a skip-down shift is required in the normal mode, may perform low stage compensation control corresponding to a select position of a gear lever, and controls an engine speed at an engaged gear stage.

The controller may control the engine at an engine speed corresponding to a 6-stage of the gear when the select position of the gear lever is row 3 and the previous gear stage exceeds the 6-stage.

The controller may control the engine at an engine speed corresponding to a 4-stage of the gear when the select position of the gear lever is row 2 and the previous gear stage exceeds the 4-stage.

The controller may control the engine at an engine speed corresponding to a 2-stage of the gear when the select position of the gear lever is row 1 and the previous gear stage exceeds the 2-stage.

According to one form of the present disclosure, it is possible to improve responsiveness of an engine by estimating a gear stage to be engaged and then controlling an engine speed in a race mode.

In addition, according to one form of the present disclosure, it is possible to reduce a shift shock and improve responsiveness of an engine by controlling an engine speed at two steps during a skip-down shift in a normal mode.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a schematic block diagram of a system for controlling an engine of a manual transmission vehicle according to one form of the present disclosure;

FIG. 2 illustrates a flowchart of a method for controlling an engine of a manual transmission vehicle according to one form of the present disclosure;

FIG. 3 illustrates a schematic drawing comparing an engine speed controlled during an upshift depending on a conventional art with an engine speed controlled during an upshift depending on a method for controlling an engine of a manual transmission vehicle according to one form of the present disclosure;

FIG. 4 illustrates a schematic drawing comparing an engine speed controlled during a downshift depending on a conventional art with an engine speed controlled during a downshift depending on a method for controlling an engine of a manual transmission vehicle according to one form of the present disclosure;

FIG. 5 illustrates a flowchart of a method for controlling an engine of a manual transmission vehicle according to another form of the present disclosure;

FIG. 6 illustrates a drawing of select positions of a manual transmission according one form of the present disclosure; and

FIG. 7 is a diagram of engine speed while a skip-down shift is performed from a 3-stage to a 1-stage depending on a method for controlling an engine of a manual transmission vehicle according to another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, and other alternative fuel vehicles (e.g. fuels derived from resources other than petroleum).

Additionally, it is understood that the various forms of the disclosed processes may be performed by one or plurality of controllers. It is understood that the term controller/control unit refers to a hardware device that includes a memory and a processor. The memory is configured to store the modules, and the processor is specifically configured to execute said modules to perform one or more processes which are described further below.

Furthermore, control logic of the present disclosure may be a non-transitory computer readable media on a computer readable medium containing executable program instructions executed by a processor, controller/control unit, or the like. Examples of the computer readable mediums include, but are not limited to, ROM, RAM, compact disc (CD)-ROMs, magnetic tapes, floppy disks, flash drives, smart cards, and optical data storage devices. The computer readable recording medium can also be distributed in network coupled computer systems so that the computer readable media is stored and executed in a distributed fashion, e.g., by a telematics server or a Controller Area Network (CAN).

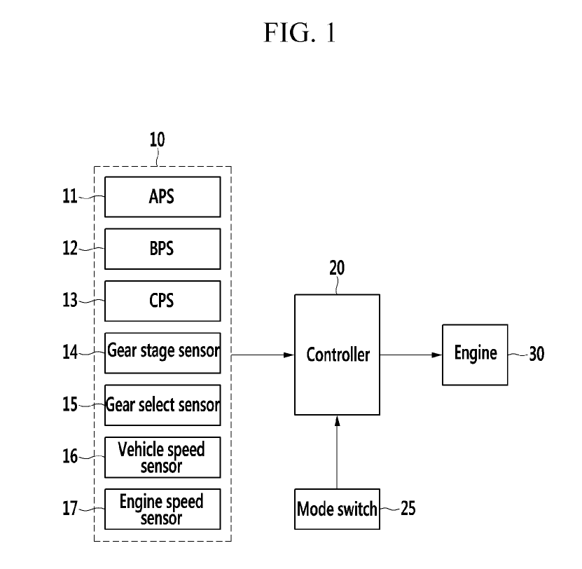

FIG. 1 illustrates a schematic block diagram of a system for controlling an engine of a manual transmission vehicle according to one form of the present disclosure.

The system for controlling an engine of a manual transmission vehicle according to one form of the present disclosure includes a data detector 10, a controller 20, a mode switch 25, and an engine 30.

The data detector 10 detects data for controlling an engine of a manual transmission vehicle, and the data detected by the data detector 10 is transmitted to the controller 20. The data detector 10 includes an accelerator position sensor (APS) 11, a brake position sensor (BPS) 12, a clutch position sensor (CPS) 13, a gear stage sensor 14, a gear select sensor 150, a vehicle speed sensor 16, and an engine speed sensor 17.

The accelerator position sensor 11 detects a degree of pressing on an accelerator pedal by a driver. In other words, the accelerator position sensor 11 detects data associated with the driver's intention of accelerating a vehicle. When the accelerator pedal is fully pressed, the position value of the accelerator pedal may be 100%, and when the accelerator pedal is not pressed, the position value thereof may be 0%.

Instead of the accelerator position sensor 11, a throttle position sensor (TPS) provided in an intake path may be used. Therefore, it is to be understood that the accelerator position sensor 11 includes the throttle position sensor and the position value of the accelerator pedal includes an opening of a throttle valve in the present disclosure.

The brake position sensor 12 detects whether the brake pedal is pressed or not. For example, the brake position sensor 12 detects data associated with the driver's intention of decelerating the vehicle. When the brake pedal is fully pressed, the position value of the brake pedal may be 100%, and when the brake pedal is not pressed, the position value of the brake pedal may be 0%.

The clutch position sensor 13 detects whether the driver pressed the clutch pedal or not. For example, the clutch position sensor 13 detects data associated with the driver's shifting intention. When the clutch pedal is fully pressed, the position value of the clutch pedal may be 100%, and when the clutch pedal is not pressed, the position value of the clutch pedal may be 0%.

The gear stage sensor 14 detects a currently engaged gear stage. Besides the gear stage sensor 14, a transmission input speed sensor may be used to detect a gear stage of the vehicle corresponding to a transmission input speed.

The gear select sensor 15 detects a select position of the gear lever when the gear lever is operated to neutral.

The vehicle speed sensor 16 detects a vehicle speed, and is installed at a wheel of the vehicle. Alternatively, the vehicle speed may be calculated based on a GPS signal received by a GPS.

The engine speed sensor 17 detects an engine speed according to a phase shift of a crankshaft or camshaft.

The mode switch 25 receives a driving mode of the manual transmission vehicle operated by the driver, and transmits a signal corresponding to the driving mode to the controller 20. For example, the mode switch 25 is turned on or turned off so that the driving mode of the vehicle may be selectively changed to a normal mode or a race mode.

Based on the data detected by the data detector 10 and the signal of the mode switch 25, the controller 20 performs engine speed control by an estimation of a gear stage according to an acceleration condition and a deceleration condition of the vehicle when the driving mode of the vehicle is the race mode, while the controller 20 performs engine speed control for compensating a low stage when the driving mode of the vehicle is the normal mode.

When the acceleration condition is satisfied in the race mode, the controller 20 controls the engine at an engine speed corresponding to an upshift, and when the deceleration condition is satisfied, the controller 20 controls the engine at an engine speed corresponding to a downshift.

Further, when a skip-down shift is required in the normal mode, the controller 20 performs low stage compensation control corresponding to a select position of the gear lever, and may control an engine speed at the engaged gear stage.

For this purpose, the controller 20 may include at least one processor or microprocessor operating by a predetermined program, and the predetermined program may be configured by a series of commands for executing a method for controlling an engine of a manual transmission vehicle according to one form of the present disclosure to be described below.

The aforementioned various forms may be in a recording medium which can be read by a computer or a similar device thereof by using, for example, software, hardware, or a combination thereof.

According to the hardware forms, the aforementioned forms may use at least one of ASICs (application specific integrated circuits), DSPs (digital signal processors), DSPDs (digital signal processing devices), PLDs (programmable logic devices), FPGAs (field programmable gate arrays), processors, controllers, microcontrollers, microprocessors, and electrical units performing other functions.

According to the software forms, such as procedures and functions described in the present disclosure may be embodied by separate software modules. The software modules may each perform one or more functions and operations described in the present disclosure. A software code may be embodied by a software application written in an appropriate program language.

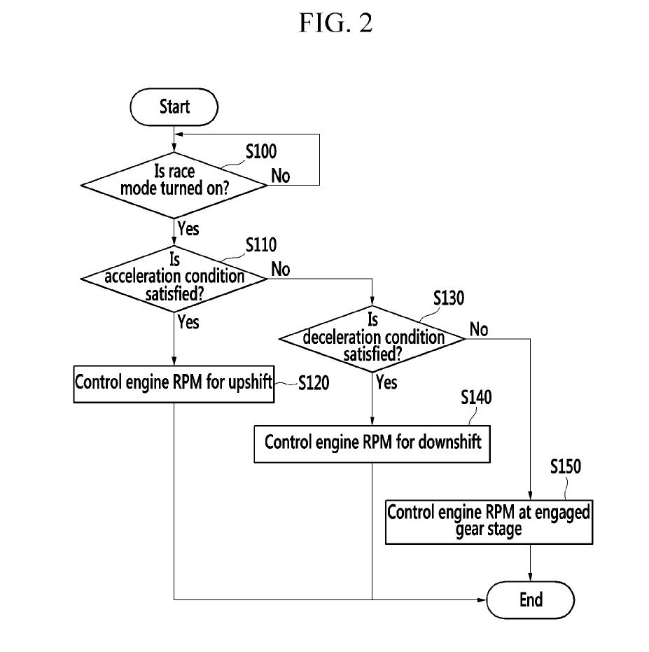

A method for controlling an engine of a manual transmission vehicle according to one form of the present disclosure will now be described in detail with reference to FIGS. 2 to 4.

FIG. 2 illustrates a flowchart of a method for controlling an engine of a manual transmission vehicle according to one form of the present disclosure.

The method for controlling an engine of a manual transmission starts by determining whether a driving mode of the vehicle is the race mode based on a signal of the mode switch 25 (S100).

In step S100, when the driving mode of the vehicle is the race mode, the controller 20 determines whether the acceleration condition is satisfied (S110).

The acceleration condition may be satisfied when the position value of the accelerator pedal is equal to or greater than a first position value, the position value of the brake pedal is less than a second position value, a vehicle speed change rate is equal to or greater than a first predetermined change rate, and the engine speed is equal to or greater than a predetermined speed, based on a signal of the data detector 10.

In step S110, when the acceleration condition is satisfied, the controller 20 controls the engine at the engine speed according to the upshift (S120).

In this case, the controller 20 decreases an engine torque to a torque corresponding to a higher gear stage than a previous gear stage by a stage, thereby controlling the engine speed. The previous gear stage may be a gear stage that is engaged within about 300 ms.

In step S110, when the acceleration condition is not satisfied, the controller 20 determines whether the deceleration condition is satisfied (S130).

The deceleration condition may be satisfied when the position value of the accelerator pedal is less than a third position value, the position value of the brake pedal is less than a fourth position value, and the vehicle speed change rate is less than a third predetermined change rate, based on a signal of the data detector 10.

In step S130, when the deceleration condition is satisfied, the controller 20 controls the engine at the engine speed according to the downshift (S140).

In this case, the controller 20 increases an engine torque to a torque corresponding to a lower gear stage than a previous gear stage by a stage, thereby controlling the engine speed. The previous gear stage may be a gear stage that is engaged within about 300 ms.

In step S130, when the deceleration condition is not satisfied, the controller 20 controls the engine at the engine speed corresponding to the engaged gear stage (S150).

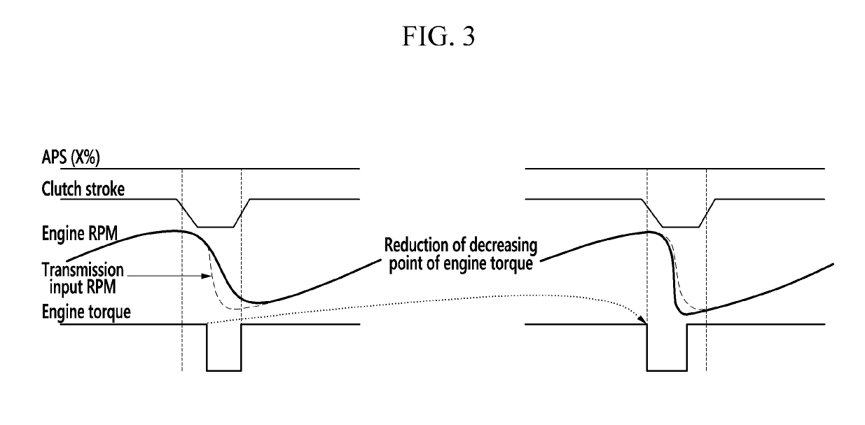

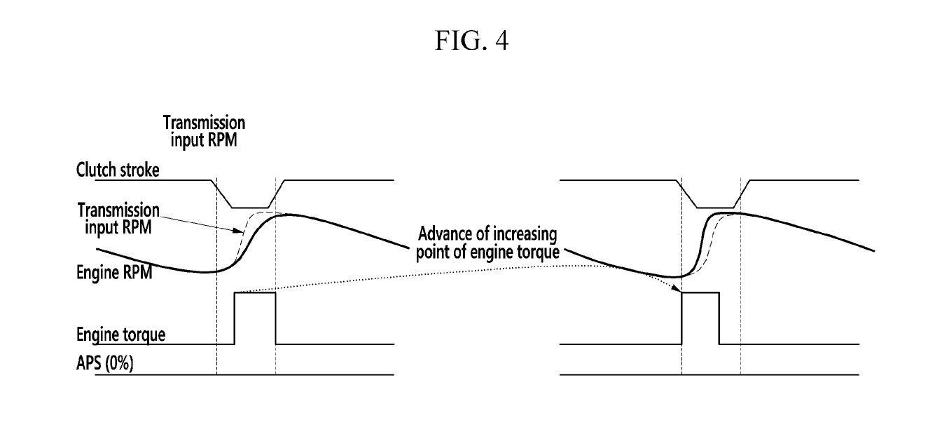

FIG. 3 illustrates a schematic drawing comparing an engine speed controlled during an upshift depending on a conventional art with an engine speed controlled during an upshift depending on a method for controlling an engine of a manual transmission vehicle according to one form of the present disclosure, and FIG. 4 illustrates a schematic drawing comparing an engine speed controlled during a downshift depending on a conventional art with an engine speed controlled during a downshift depending on a method for controlling an engine of a manual transmission vehicle according to one form of the present disclosure.

As shown in FIG. 3, according to the method for controlling the engine of the manual transmission vehicle according to one form of the present disclosure, a decreasing point of the engine torque may be reduced more than the conventional art during the upshift. Therefore, it is possible to be synchronized at an engine speed corresponding to a gear stage to be engaged by controlling an engine speed earlier than a transmission input speed.

In addition, as shown in FIG. 4, an increasing point of the engine torque may be advanced more than the conventional art during the downshift. Therefore, it is possible to be synchronized at an engine speed corresponding to a gear stage to be engaged by controlling an engine speed earlier than the transmission input speed.

As such, according to one form of the present disclosure, it is possible to implement rapid responsiveness of an engine by estimating a gear stage to be engaged and then controlling an engine speed in a race mode.

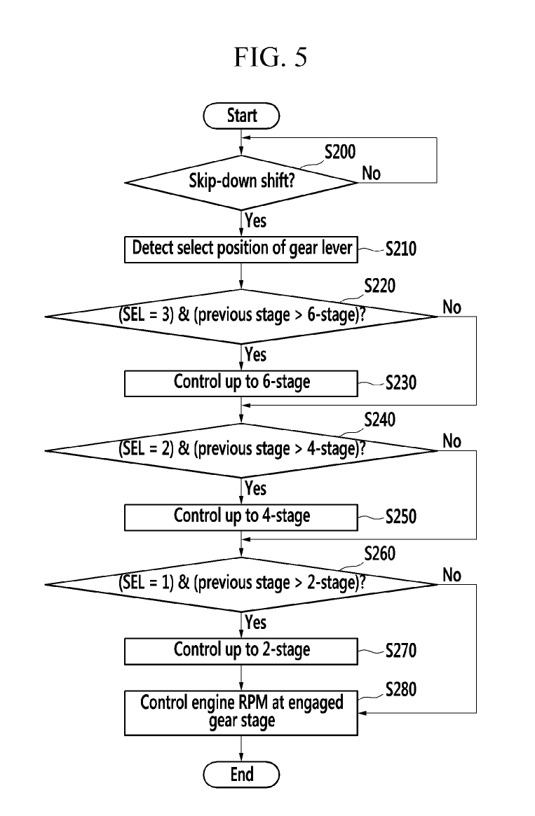

A method for controlling an engine of a manual transmission vehicle according to another form of the present disclosure will now be described in detail with reference to FIGS. 5 to 7.

FIG. 5 illustrates a flowchart of a method for controlling an engine of a manual transmission vehicle, which starts by determining whether a skip-down shift is required based on the signal of the data detector 10 (S200).

In step S200, when the skip-down shift of the vehicle is required, the controller 20 detects a select position of the gear lever (S210).

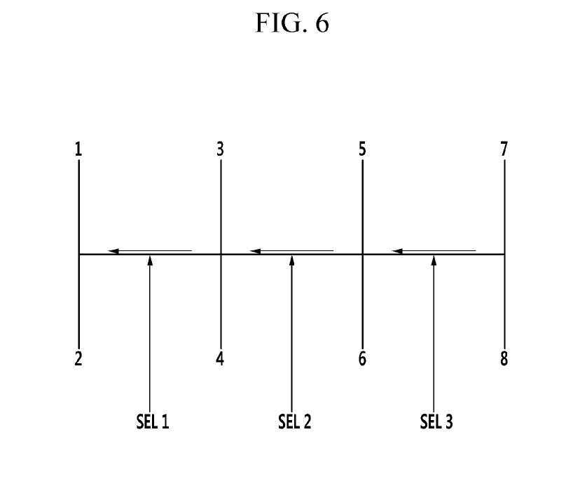

FIG. 6 illustrates a drawing of the select positions of the gear lever for a manual transmission according to one form of the present disclosure.

As shown in FIG. 6, the gear lever is typically moved in an H-shape, and a horizontal direction thereof is referred to as “select” and a vertical direction thereof is referred to as “shift.”

In one form of the present disclosure, neutral states are when the gear lever is not engaged to the gear stage, and are divided to detect a select position into a select row 1 (SEL 1), a select row 2 (SEL 2), and a select row 3 (SEL 3). That is, select row 1 is between 1-2 stages and 3-4 stages, select row 2 is between 3-4 stages and 5-6 stages, and select row 3 is between 5-6 stages and 7-8.

In step S210, when the select position of the gear lever is detected, the controller 20 determines whether the select position is row 3 (SEL 3) and the previous gear stage exceeds a 6-stage (S220).

In step S220, when the select position of the gear lever is row 3 (SEL 3) and the previous gear stage exceeds the 6-stage, the controller 20 controls the engine at an engine speed corresponding to the 6-stage of the gear (S230).

In step S220, when the select position of the gear lever is not row 3 (SEL 3) or the previous gear stage is equal to or less than the 6-stage, the controller 20 determines whether the select position is row 2 (SEL 2) and the previous gear stage exceeds a 4-stage (S240).

In step S240, when the select position of the gear lever is row 2 (SEL 2) and the previous gear stage exceeds the 4-stage, the controller 20 controls the engine at an engine speed corresponding to the 4-stage of the gear (S250).

In step S240, when the select position of the gear lever is not row 2 (SEL 2) or the previous gear stage is equal to or less than the 4-stage, the controller 20 determines whether the select position is row 1 (SEL 1) and the previous gear stage exceeds a 2-stage (S260).

In step S260, when the select position of the gear lever is row 1 (SEL 1) and the previous gear stage exceeds the 2-stage, the controller 20 controls the engine at an engine speed corresponding to the 2-stage of the gear (S270).

That is, the controller 20 may perform the low stage compensation control depending on the select position of the gear lever by sequentially determining the select position of the gear lever and the gear stage through steps S220, S240, and S260.

Next, the controller 20 controls the engine at the engine speed corresponding to the engaged gear stage (S280).

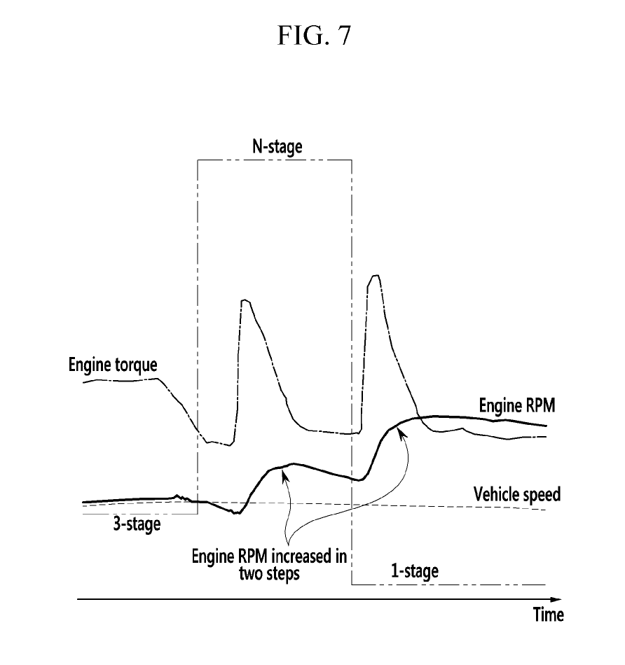

FIG. 7 is a diagram of engine speed while a skip-down shift is performed from a 3-stage to a 1-stage depending on a method for controlling an engine of a manual transmission vehicle according to another form of the present disclosure.

As shown in FIG. 7, when a current gear stage of the vehicle is shifted from the 3-stage to the 1-stage as the skip-down shift, the gear lever is positioned at the select row 1 (SEL1) in an N-stage. In this case, the controller 20 first performs the low compensation of the 2-stage to increase the engine torque, and controls the engine at an engine speed corresponding to the 2-stage of the gear.

Next, when the engine speed is synchronized with the engine speed corresponding to the 2-stageof the gear, the controller 20 further increases the engine torque to control the engine at the engine speed corresponding to the 1-stage of the engaged gear.

That is, according to one form of the present disclosure, it is possible to control the engine speed in two steps during the skip-down shift. For example, an engine speed increases up to 3000 RPMs according to the conventional art, while the engine speed according to one form of the present disclosure may first increase up to 1000 RPM and then may further increase up to 2000 RPM.

As described above, according to one form of the present disclosure, it is possible to reduce shift shock and improve responsiveness of an engine by controlling an engine speed in two steps during a skip-down shift in a normal mode.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for controlling an engine of a manual transmission vehicle, comprising:
determining a driving mode of a vehicle;
determining an acceleration condition and a deceleration condition when the driving mode of the vehicle is a race mode;
controlling the engine at an engine speed corresponding to an upshift when the acceleration condition is satisfied; and
controlling the engine at an engine speed corresponding to a downshift when the deceleration condition is satisfied.

2. The method for controlling the engine of the manual transmission vehicle of claim 1, wherein
the acceleration condition is satisfied when a position value of an accelerator pedal is equal to or greater than a first position value, a position value of a brake pedal is less than a second position value, a vehicle speed change rate is equal to or greater than a first predetermined change rate, and an engine speed is equal to or greater than a predetermined speed.

3. The method for controlling the engine of the manual transmission vehicle of claim 1, wherein
the deceleration condition is satisfied when the position value of the accelerator pedal is less than a third position value, the position value of the brake pedal is less than a fourth position value, and the vehicle speed change rate is less than a third predetermined change rate.

4. The method for controlling the engine of the manual transmission vehicle of claim 1, wherein
the controlling of the engine at the engine speed corresponding to the upshift includes decreasing an engine torque to a torque corresponding to a higher gear stage than a previous gear stage by a stage to control the engine speed.

5. The method for controlling the engine of the manual transmission vehicle of claim 1, wherein
the controlling of the engine at the engine speed corresponding to the downshift includes increasing an engine torque to a torque corresponding to a lower gear stage than the previous gear stage by a stage to control the engine speed.

6. The method for controlling the engine of the manual transmission vehicle of claim 1, further comprising:
controlling the engine at an engine speed corresponding to an engaged gear stage when the acceleration condition and the deceleration condition are not satisfied.

7. The method for controlling the engine of the manual transmission vehicle of claim 1, further comprising:
determining whether a skip-down shift of the vehicle is required when the driving mode of the vehicle is a normal mode;
detecting a select position of a gear lever when the skip-down shift is required;
performing low stage compensation control depending on the select position of the gear lever; and
controlling the engine at the engine speed corresponding to the engaged gear stage.

8. The method for controlling the engine of the manual transmission vehicle of claim 7, wherein
the performing of the low stage compensation control depending on the select position of the gear lever includes:
controlling the engine at an engine speed corresponding to a 6-stage of the gear when the select position of the gear lever is row 3 and the previous gear stage exceeds the 6-stage;
controlling the engine at an engine speed corresponding to a 4-stage of the gear when the select position of the gear lever is row 2 and the previous gear stage exceeds the 4-stage; and
controlling the engine at an engine speed corresponding to a 2-stage of the gear when the select position of the gear lever is row 1 and the previous gear stage exceeds the 2-stage.

9. A system for controlling an engine of a manual transmission vehicle, comprising:
a data detector configured to detect data for controlling an engine of a vehicle;
a mode switch configured to determine a driving mode of the vehicle; and
a controller configured to perform engine speed control by estimation of a gear stage according to an acceleration condition and a deceleration condition of the vehicle when the driving mode of the vehicle is a race mode, and to perform the engine speed control for compensating a low stage when the driving mode of the vehicle is a normal mode, based on the data detected by the data detector.

10. The system for controlling the engine of the manual transmission vehicle of claim 9, wherein
the controller, in the race mode, controls the engine at an engine speed corresponding to an upshift when the acceleration condition is satisfied.

11. The system for controlling the engine of the manual transmission vehicle of claim 10, wherein
the controller decreases an engine torque to a torque corresponding to a higher gear stage than a previous gear stage by a stage to control the engine speed.

12. The system for controlling the engine of the manual transmission vehicle of claim 10, wherein
the acceleration condition is satisfied when a position value of an accelerator pedal is equal to or greater than a first position value, a position value of a brake pedal is less than a second position value, a vehicle speed change rate is equal to or greater than a first predetermined change rate, and an engine speed is equal to or greater than a predetermined speed.

13. The system for controlling the engine of the manual transmission vehicle of claim 9, wherein
the controller controls the engine at an engine speed corresponding to a downshift when the deceleration condition is satisfied in the race mode.

14. The system for controlling the engine of the manual transmission vehicle of claim 13, wherein
the controller increases an engine torque to a torque corresponding to a lower gear stage than the previous gear stage by a stage to control the engine speed.

15. The system for controlling the engine of the manual transmission vehicle of claim 13, wherein
the deceleration condition is satisfied when the position value of the accelerator pedal is less than a third position value, the position value of the brake pedal is less than a fourth position value, and the vehicle speed change rate is less than a third predetermined change rate.

16. The system for controlling the engine of the manual transmission vehicle of claim 9, wherein
the controller controls the engine at an engine speed corresponding to an engaged gear stage when the acceleration condition and the deceleration condition are not satisfied.

17. The system for controlling the engine of the manual transmission vehicle of claim 9, wherein
the controller, when a skip-down shift is required in the normal mode, performs low stage compensation control corresponding to a select position of a gear lever, and controls an engine speed at an engaged gear stage.

18. The system for controlling the engine of the manual transmission vehicle of claim 17, wherein
the controller controls the engine at an engine speed corresponding to a 6-stage of the gear when the select position of the gear lever is row 3 and the previous gear stage exceeds the 6-stage.

19. The system for controlling the engine of the manual transmission vehicle of claim 17, wherein
the controller controls the engine at an engine speed corresponding to a 4-stage of the gear when the select position of the gear lever is row 2 and the previous gear stage exceeds the 4-stage.

20. The system for controlling the engine of the manual transmission vehicle of claim 17, wherein
the controller controls the engine at an engine speed corresponding to a 2-stage of the gear when the select position of the gear lever is row 1 and the previous gear stage exceeds the 2-stage.
